(19) United States
(12) Patent Application Publication
(10) Pub. No.: US 2023/0209351 A1
(43) Pub. Date: Jun. 29, 2023

(54) ASSESSING RISK OF FRAUD ASSOCIATED WITH USER UNIQUE IDENTIFIER USING TELECOMMUNICATIONS DATA

(71) Applicant: TeleSign Corporation, Marina del Rey, CA (US)

(72) Inventors: Gordana Djankovic, Belgrade (RS); Ravishkumar M. Patel, Los Angeles, CA (US)

(21) Appl. No.: 17/564,013

(22) Filed: Dec. 28, 2021

(51) Int. Cl. H04W 12/12; H04W 12/48

(52) U.S. Cl. CPC H04W 12/12; H04W 12/48

(57) ABSTRACT

A system and methods for assessing risk of fraud associated with a unique identifier associated with a telecommunication device of a user. The disclosed system utilizes one or more datasets of traffic representing network sessions over a telecommunications network. The system uses machine learning techniques to analyze network session data and/or static or dynamic attributes characterizing the network session data, and generates a risk scoring model that assesses the likelihood that the user is associated with fraudulent activities. The system receives a unique identifier and queries the one or more datasets for data characterizing traffic over the telecommunications network associated with the unique identifier. The system analyzes the traffic data associated with the unique identifier based on the risk scoring model and generates a score, grade, reason code, or other characterization indicating the likelihood of fraud associated with the unique identifier.

### BACKGROUND

Service providers such as providers of online or other network-accessible services (e.g., web sites, mobile applications, cloud applications, etc.) regularly register users who wish to access their services. Unfortunately, some users of online or network-accessible services may seek to misuse such services such as by creating online or mobile application accounts for purposes of spam, phishing attacks, promo abuse, or other fraudulent or disruptive activities. Through the registration of fake accounts, fraudsters can misuse services and damage a brand's value, revenue and growth. Thus, service providers may wish to identify and remove users who are likely associated with fraudulent or other disruptive activities.

Many service providers now rely on authentication processes that take advantage of a user's mobile phone as a second means of authenticating a user, and it is not uncommon for service providers to require mobile phone numbers as part of account registration processes. A user's mobile phone might be used as a second authentication factor or to contact a user. Therefore, it would be advantageous for service providers or other entities to be able to assess the likelihood that a mobile phone associated with a user will be or has been associated with undesirable activities such as fraud, spam, phishing attacks, promo abuse, or other fraudulent or disruptive activities.

### BRIEF DESCRIPTION OF THE DRAWINGS

FIG. 1 is a diagram of a representative environment in which a system for assessing risk of fraud associated with a unique identifier may operate.

FIG. 2 is a block diagram illustrating components of a system for assessing risk of fraud associated with a unique identifier.

FIG. 3 is a flow diagram illustrating a method for generating a scoring model to determine likelihood of fraudulent activity based on telecommunications traffic data.

FIG. 4 is a flow diagram illustrating a method for generating a risk score for a unique identifier to indicate likelihood that the unique identifier is associated with fraudulent activity.

FIGS. 5A-5B are graphs illustrating aging of a risk score used to assess risk of fraud associated with a unique identifier.

The techniques introduced in this disclosure can be better understood by referring to the following Detailed Description in conjunction with the accompanying drawings.

### DETAILED DESCRIPTION

Many mobile devices such as mobile phones, tablets, and wearable devices can connect with telecommunication networks to allow users of those devices to place telephone calls. To access telecommunication services and send and receive calls, mobile devices are associated with one or more unique identifying numbers or other identifiers (e.g., a telephone number, IMSI, NEI). When telephone calls or messages are transmitted from devices, telecommunication networks can associate such uses with specific devices or users based on the unique identifiers associated with such devices or users. Telecommunication networks and other networks can, therefore, generate and store data regarding use of and traffic to and from devices based on user unique identifiers. For example, a telecommunications network can generate and store a variety of information related to a particular phone number such as tenure (length of time that a number has been in use), location of call origin, location of call recipients, number of calls made or received, duration of calls made or received, and so on. Because mobile devices are typically associated with a single individual, or are associated with the account of a single individual, the stored network information reflects the use pattern of that individual.

A system and method are disclosed herein for assessing the risk of fraud associated with a user unique identifier (e.g., a phone number, IMSI, IMEI, IP address, etc.) based on telecommunication traffic and use data, such as data relating to use of cellular networks. To assess risk of fraud, the system utilizes a risk scoring model. The risk scoring model is generated by the system using a dataset of network traffic and use data that has been gathered over a specified time period (e.g., data and metadata regarding all calls and messages sent or received over a mobile telecommunications network for the last 90 days). Network traffic and use data is analyzed by the system and various dynamic and static attributes related to that traffic is identified by the system. Traffic associated with different user identifiers is then partitioned into different clusters based on the static and/or dynamic attributes of that traffic (e.g., the rate/velocity of traffic associated with that user identifier). After partitioning into clusters, the system relies upon knowledge of specific known fraudulent and non-fraudulent users in each cluster in order to train a machine learning (ML) model associated with that cluster. The machine learning algorithm finds patterns in the network traffic and use dataset, including any static and/or dynamic attributes characterizing that network traffic, that predict the likelihood of fraudulent activity. The system then outputs an ML model that is trained to identify those patterns. Those patterns might be based on, for example, common static or dynamic attributes of fraudulent and non-fraudulent users (e.g., call duration, number and frequency of calls sent and received, tenure of a particular phone number) and attribute ranges indicative of those users (e.g., range of call frequencies that may indicate that the user is engaged in fraudulent activities). The patterns may also be directly derived from the network traffic and use dataset. Each ML model is trained to output a score that is based on the likelihood that the unique user identifier is associated with fraudulent activity. The resulting clustering methodology and ML model generated for each cluster are stored by the system as the risk scoring model to be applied by the system. The risk scoring model can also assess qualitative information about user behaviors, such as by generating reason codes that provide information about attributes or other factors affecting a generated risk score.

After the risk scoring model has been generated by the system, the system utilizes the model to assess the likelihood that a unique identifier (e.g., a phone number) associated with a user or device is associated with fraud or other undesirable or disruptive activities. Upon receiving a unique identifier associated with a user or device, such as associated with a registration request to an online or other service, the system queries a dataset of telecommunications data for traffic and use data associated with the user unique identifier. For example, the system can request data related to all calls and messages sent or received by a particular phone number over a telecommunication network during a defined time period. The system receives traffic and use data associated with the unique identifier and analyzes the data using the risk scoring model to assess attributes indicative of fraudulent or otherwise undesirable activities. That is, based on the analysis of the traffic and use data associated with the unique identifier and corresponding static or dynamic attributes of that data or the unique identifier, the risk scoring model assigns the unique identifier to a cluster and applies the ML model associated with that cluster to the traffic and use data and/or any characterizing static or dynamic attributes associated with that unique identifier. For example, based on an unusual frequency of calls generated from the phone number, the phone number might be identified as associated with a cluster of high frequency calls. By applying the ML model associated with high frequency calls to the traffic and use data and/or any static or dynamic attributes associated with the unique identifier, the system generates a score (e.g., a numeric score within a specified range), grade, or other characterization that is indicative of the likelihood that the user or device associated with the unique identifier is associated with fraudulent or other undesirable behaviors (e.g., phishing, spam, promo abuse, and so on). For example, the system can be configured to generate a numerical score between 0 and 1000, wherein a relatively high numerical score indicates a greater likelihood that a given phone number is likely to be used in relation to fraudulent activities. In some implementations, the system also generates a reason code to explain, for example, a likely user class associated with the unique identifier, and the reason for a specific score generated by the system. The generated score may be used to deny the mobile device user access to certain websites or services if the score indicates that the identifier is likely associated with fraudulent activities. A reason code may also provide information about other user identifiers or behaviors associated with a unique identifier, such as an email address or Internet Protocol (IP) address. For example, the reason code may indicate that the email or IP address is associated with long-term activity on risky services.

While the system has been described to distinguish between fraudulent and non-fraudulent users, it will be appreciated that it can also be utilized to identify other classes or categories of users as well. For example, the system can categorize users as good users, call centers, or applications. Any class of user may have a particular pattern of historical network traffic that can be used to train a model to detect that class of user using future network traffic.

Advantages of the present system include improved user classification and fraud detection capabilities, and the ability to utilize richer datasets not typically associated with fraud assessment. Through machine learning, the system can leverage extensive data related to use of telecommunication networks to identify traffic attributes indicative of various classes of network users. Thus, the present system is better able to identify classes of users based on the identified traffic attributes, including detecting fraudulent users. In other words, the present system improves technology for network user classification and fraud detection using machine learning to analyze network traffic.

Various implementations of the invention will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

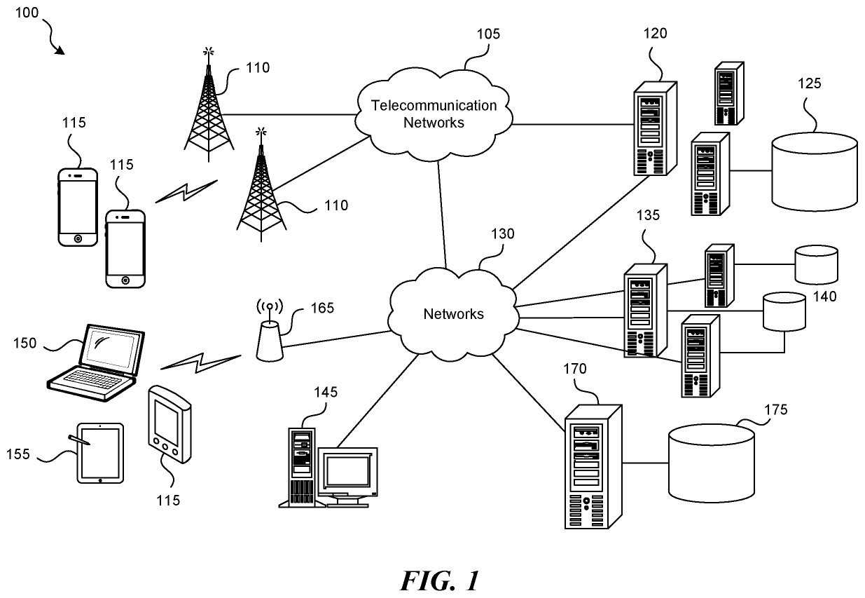

FIG. 1 and the following discussion provide a general description of a suitable environment in which a system for assessing risk of fraud associated with a user unique identifier using telecommunications data may operate. Although not required, aspects of the system are described in the general context of computer-executable instructions, such as routines executed by a general-purpose computer, a personal computer, a server, or other computing system. The system can also be embodied in a special purpose computer or data processor that is specifically programmed, configured, or constructed to perform one or more of the computer-executable instructions explained in detail herein. Indeed, the terms “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programming logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

Aspects of the system can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the system described herein may be stored or distributed on tangible, non-transitory computer-readable media, including magnetic and optically readable and removable computer discs, stored in firmware in chips (e.g., EEPROM chips). Alternatively, aspects of the system may be distributed electronically over the Internet or over other networks (including wireless networks). Those skilled in the relevant art will recognize that portions of the system may reside on a server computer, while corresponding portions may reside on a client computer.

FIG. 1 depicts an environment 100 that includes multiple different communication paths that allow users to access various telecommunication and network services. One set of services are provided by fixed and wireless telecommunication networks 105 which are operated by telecommunication network operators, such as consumer-facing operators like T-Mobile, Vodaphone, Verizon, etc., alone or in partnership with wholesale carriers like BICS, Deutsche Telekom Global Carrier, etc. For wireless portions of a telecommunications network, telecommunication network operators typically own or lease access to cell towers 110 that are connected to extensive backend networks to route telecommunications traffic to and from mobile devices 115 and other fixed or wireless termination points. Network traffic over the telecommunication networks 105 is managed and tracked via one or more servers 120. Servers 120 monitor call set-up, call termination, call length, device identifiers, and various other parameters described in further detail below that are associated with each user communication session. The data characterizing traffic from, to, or between mobile devices 115 across telecommunication networks 105 is stored by servers 120 in one or more datasets in various data warehouses 125.

A second set of services includes various network services, such as websites, video services, music services, financial services, storage services, etc. that are accessed via data networks 130. Those services are provided by service providers such as Amazon.com, Google, Facebook, Apple, Spotify, etc. using one or more servers 135 typically co-located in server farms. Servers 135 are coupled to one or more datasets in various data warehouses 140 for purposes of providing the offered services. Users access offered services using personal computer devices 145, laptop computers 150, tablet computers 155, mobile devices 115 and wearable devices (not shown). Access is provided to the services via data networks 130 which can be wired or wireless, public or private, networks including, for example, the Internet. Networks may be accessed via wireless hotspots 165 that operate, for example, in accordance with the WiFi standard. While depicted as separate networks in FIG. 1, it will be appreciated that data networks 130 and telecommunication networks 105 may overlap or share network components, in whole or in part.

A third service depicted in FIG. 1 is the risk assessment service provided by the risk assessment system. As will be described in more detail herein, the risk assessment system may in part reside on servers 170 and/or data storage area 175. The risk assessment system is used to assess the risk that a particular user of a mobile device 115 is likely to have fraudulent intent or to be seeking access to services for fraudulent purposes. The risk assessment system may therefore be used by service providers to assist with processing a registration request from a user who is utilizing mobile communication devices 115, personal computer 145, laptop computer 150, or tablet computer 155 to request access to the aforementioned online services or other network-accessible services (e.g., web sites, mobile applications, cloud applications, etc.). For example, a user may attempt to register an account to access a mobile application, and the system may assess the risk, as described herein, that the user is registering an account for fraudulent purposes based on a unique identifier (e.g., a phone number) provided by the user through the registration request. In an example implementation, a service provider submits a user identifier to the risk assessment system via an API, and the system performs a risk assessment based on the user identifier. Based on the risk assessment, the system provides to the service provider a user category or class, a risk score, a risk level (low, medium, high, etc.), and/or a recommendation (allow, flag, block, etc.), which the service provider can use to decide whether to verify the user for the service or to require additional information from the user. In some implementations, the system also provides to the service provider a reason code, which can include details regarding the user category or class, the risk score, the risk level, and/or the recommendation, such as additional information about user activity and attributes associated with the identifier.

As an example of the risk assessment service, if the service provider provides a unique identifier such as a phone number, IP address, and/or email address of the user for verification purposes (account creation, login, online payment, account update, etc.), the system uses that unique identifier to calculate and validate behavioral/dynamic and static attributes related to the provided unique identifier. The behavioral/dynamic and static attributes are determined, for example, by analysis of traffic and use data associated with the identifier. The system then assesses the traffic and use data and/or the dynamic and static attributes using trained machine learning models to return score points representing a probability that the user is associated with fraudulent activity. This probability is transformed into a scaled numerical score from 1 to 1000. The system further generates a corresponding risk level, a recommendation, and/or a reason code (e.g., a list of the aggregated dynamic and static attributes that are influencing the score). The scaled numerical score, as well as the corresponding risk level, recommendation, and/or reason code are transmitted by the system to the service provider. The service provider can use any of those output data points (e.g. score points at some threshold and/or recommendation) for a straightforward “allow/block” decision, or can incorporate score results into their own fraud detection system and use them as a first-level defense and/or as a set of rules (e.g. if Score >900 then Block; if Score >800 and <900 then require additional verification; if Score >600 and <800 then Allow but monitor; or if Score >600 and <800 and reason code contains ‘high short-term activity on risky services’ then Block, etc.), and so on.

To assess risk of unique identifiers, the risk assessment system utilizes a risk scoring model that is based on historical stored data relating to calls and messages sent and received over the telecommunications network 105 during an analyzed time period. In some embodiments, the stored data characterizing network traffic may be transmitted to the server computer 170 and stored in data storage area 175. In some embodiments, the stored data may be directly accessed from data warehouse 125. The disclosed risk assessment technology utilizes all or portions of the stored traffic data to train one or more ML models that make up the risk scoring model, as described herein.

After generation of the risk scoring model, the risk assessment system uses the model to assess risk of a provided unique identifier associated with a mobile device. For example, a user may attempt to register an account using a personal computer to access an application residing on the server computer, and the system may operate to assess the risk that the user and/or the user's associated one or more devices are likely to have engaged in fraudulent behaviors such as spam, phishing attacks, promo abuse, and so on. To assess risk, the system queries the stored traffic data for information relating to the unique identifier. For example, the system may query the generated data for information regarding all calls and messages sent and received by a mobile communication device 115 associated with the unique identifier (e.g., a phone number) over a telecommunications network 105 for a specified time period. In some embodiments, the unique identifier may be associated with another device type, such as a landline telephone, a laptop computer 150, a tablet computer 155, a personal computer device 145, or a wearable device. While the unique identifier is typically a phone number, the unique identifier can be any identifier that uniquely identifies the device (and, by implication, the user), such as an IMSI, IMEI, ICCID number, or IP address. The system then analyzes the traffic data for certain static and/or dynamic attributes associated with the unique identifier. Based on the identified static or dynamic attributes, the risk scoring model applies an appropriate trained ML model to generate a likelihood that the unique identifier is associated with or likely to commit fraudulent activity. The dataset of telecommunications network traffic and use data may reside on the one or more data storage areas associated with the telecommunication server computers, on the data storage area associated with the server computer, or elsewhere.

The data storage area 175 contains data utilized by the risk assessment system and, in some implementations, software used to perform functions of the system. For example, the data storage area 175 may contain one or more datasets associated with known user classes (e.g., telephone numbers and associated data for users known or suspected to engage in fraudulent activities, telephone numbers and associated data for users known or suspected to be non-fraudulent, etc.), and one or more datasets of aggregated data of all activities conducted over a telecommunications network 105 for a specified time period. The data storage area 175 may also contain, for example, software used to analyze the foregoing datasets and generate the risk scoring model, as described herein, as well as software used to apply the risk scoring model in response to received unique identifiers (e.g., generating a score for a given phone number).

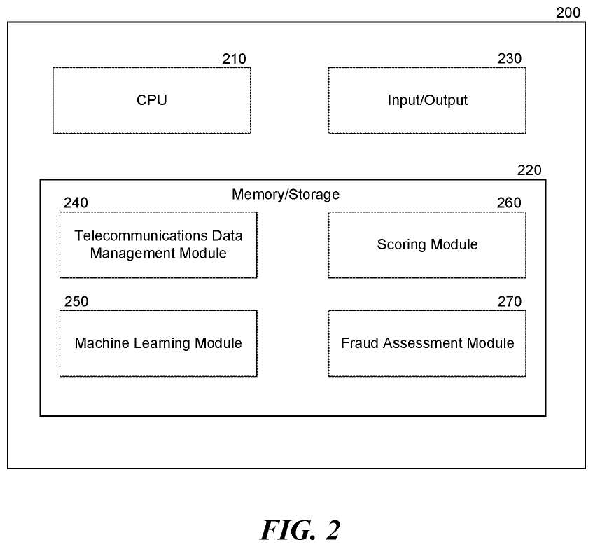

FIG. 2 is a block diagram illustrating example components of a system 200 for assessing risk of fraud associated with a unique identifier. As shown in FIG. 2, the system 200 includes one or more central processing units (CPU) 210 for executing software stored in a memory 220. The system 200 also includes an input/output (I/O) module 230 that is coupled to the CPU 210. The I/O module 230 can be a network card, video card, audio card, USB port, FireWire port, or other wired or wireless interface that allows data to be either input to the system 200 (e.g., from a keyboard, mouse, touchpad or touch panel) or output to another device (e.g., a monitor, computer, printer, or other output mechanism).

The memory 220 stores software modules which perform certain methods or functions of the system 200, and can include components, subcomponents, or other logical entities that assist with or enable the performance of some or all of these methods or functions. The modules include a telecommunications data management module 240, a machine learning (ML) module 250, a scoring module 260, and a fraud assessment module 270, each of which will be described in more detail below.

The system 200 may receive telecommunications network traffic and use data in a variety of forms. For example, the system may receive one or more files containing a dataset which represents network traffic (e.g., phone calls) conducted over a telecommunications network. The dataset typically includes a unique identifier associated with the originating device, a unique identifier associated with the terminating device, the date and time that the corresponding network session (e.g., phone call) was initiated, the length of the network session (represented by, for example, a session length or a session termination date and time), routing information of the network session, and other characterizing information. The system 200 can receive telecommunications data, for example, in the form of billing CDRs (call detail records). The CDRs are data records produced by a telephone exchange or other telecommunications equipment that documents the details of a telephone call or other telecommunications transaction (e.g., text message) that passes through that facility or device. Each CDR contains various attributes of the call, such as time, duration, completion status, source number, and destination number. A CDR can include various fields for each attribute, such as a call identifier, a communication type (e.g., voice call, SMS or other text message, etc.), one or more time stamps, operator information (e.g., originating operator, transmitting operator, receiving operator, destination operator, and/or identifiers, identities, or locations associated with the foregoing), phone number calling or called, length of SMS or other text message, duration of phone call, call setup duration, customer or carrier information, call status information (successful, unsuccessful, error information, etc.), release direction information, whether a call was answered, phone number type information (calling or called), and so forth.

The telecommunications data management module 240 aggregates and processes telecommunications network traffic data received by the system 200. The data management module 240 may, for example, store the received data in batches representing all traffic over a telecommunications network during a set period. For example, the data management module 240 may aggregate and then partition the data to store the data in batches that represent two hours of network traffic. In some implementations, the data management module 240 extracts from the received data a base set of data that consists of telecommunications network data corresponding to only the last network session for each unique identifier represented in the batch (hereinafter referred to as “base set”). Data stored by the data management module 240 is used by the machine learning module 250 to train a machine learning model, as described below, and by the scoring module 260 and the fraud assessment module 270 to assess fraud risk and generate risk scores, reason codes, recommendations, and so forth, as further described below.

The data management module 240 further processes received telecommunications network data in order to assess various static and dynamic attributes of the data. For example, if the unique identifier is a phone number, static attributes that are identified for each phone number may include a number type (e.g., toll free, landline, mobile, etc.), operator name and country, whether the number is associated with a value-added service (VAS), whether the number is associated with application-to-person (A2P) messaging, and so on. Dynamic attributes associated with a phone number may include a number of active days during which a phone number exceeded a threshold number of communication sessions, a number of successful and unsuccessful communication sessions associated with a phone number, a number of different phone numbers with which the phone number has engaged in sessions, and so on. In some implementations, the data management module 240 determines the foregoing attributes using the base set of unique identifiers extracted from the received data.

The system 200 maintains or periodically receives lists of unique identifiers that are associated with fraudulent activity. That fraudulent activity could include service misuse, promo abuse, spam, phishing attacks, or any other fraudulent or disruptive activities. Identifiers associated with fraudulent activity may be identified by the system operator or by providers of services that report misuse of their service. The data management module 240 stores a list of unique identifiers associated with the suspected fraudulent users in a dataset. The data management module 240 may also store a list of unique identifiers associated with non-fraudulent users as well.

The stored lists of fraudulent and non-fraudulent users are used as a training dataset by the system 200 to build one or more ML models for recognizing likely fraudulent users. Initially, the system identifies all stored network traffic information associated with the list of known fraudulent users and non-fraudulent users. That is, the system searches stored data characterizing past telecommunication network sessions to identify all telecommunication network sessions that are associated with the unique identifiers of each user. Once the historical network traffic information has been compiled, the system may identify or calculate various static or dynamic attributes that characterize each session or set of sessions. The ML module 250 then uses the network traffic information, including any characterizing attributes, to train one or more risk scoring models using machine learning techniques. The characterizing attributes may be used by the ML module 250 to partition the network traffic information into one or more clusters, wherein the clusters are associated with users having similar characteristics. The ML module may use either supervised (e.g., Linear Regression, Logistic Regression, CART, Naive Bayes, KNN, Random Forest, XGBoost) or unsupervised (e.g., Apriori, K-means, PCA, density-based spatial clustering of applications with noise (DBSCAN), hierarchical clustering) learning techniques in order to analyze the historical network data in each cluster and determine characteristics of that data that are indicative that corresponding users are more or less likely to commit fraudulent activity. The ML module 250 trains a ML model for each cluster using the network data, as well as ranges and weights for the attributes, that are indicative of fraudulent and non-fraudulent users. The various ML models that are trained by the ML module 250 are stored as the risk scoring model at the scoring module 260. Those models are trained to detect patterns based on traffic patterns and/or static or dynamic attributes that are correlated with certain behaviors, whether good or bad. The models output a score, which can be scaled between 1-1000, where the score correlates with the relative risk level of the associated user.

Once the risk scoring model has been generated by the ML module 250, it is used by the system to assess the likelihood that newly-identified unique identifiers are associated with fraudulent behavior. The scoring module 260 applies the risk scoring model generated by the ML module 250 and generates numerical scores, risk levels, categories, and recommendations for specific identifiers. The scoring module 260 receives as input a unique identifier associated with a user. The scoring module 260 accesses the one or more datasets of telecommunications network traffic data in order to identify past network sessions associated with that unique identifier. Using the past network session data, the scoring module 260 calculates static and dynamic attribute values associated with the received identifier, identifies the appropriate ML model to apply to the session data and/or static/dynamic attribute values, and generates a risk score to indicate the likelihood that the unique identifier is associated with fraud. For convenience in interpretation, the output of the scoring module 260 may be a numerical score, for example, between 0 and 1000, wherein a lower score indicates a lower likelihood that the phone number is associated with fraud and a higher score indicates a higher likelihood that the phone number is associated with fraud. In some embodiments, however the risk score may be an alphanumeric assessment (e.g., “A” through “F”), a narrative assessment (e.g., “high,” “medium high,” “medium,” “medium low,” and “low”), or other indication expressing relative risk.

In addition to generating a risk score, such as a numerical score quantifying user behaviors associated with a user identifier, the scoring module 260 can also generate qualitative indications of user behaviors, such as reason codes. Reason codes can be, for example, indications of factors (e.g., patterns, attribute values, behaviors associated with an identifier, etc.) that materially affect a classification of a user identifier. Reason codes can be internal, such that they are not visible to a user of the system and are only used for generating risk scores, as described herein. Additionally or alternatively, reason codes can be external, such as reason codes that are provided to a user of the system to further explain a generated risk score, risk level, user category, or recommendation. Reason codes can also be combined or aggregated reason codes, for example, to help explain a combined risk score. Reason codes can be presented, for example, using JSON code and stored in a table or list.

A reason code can be generated or expressed as a concatenation of multiple blocks of characterizing data. In some embodiments, the reason code takes the following format:

| | | | | | |
|---|---|---|---|---|---|
| Category | ID_type | Traffic Type 1: | Traffic Type 2: | Traffic Type 3: | . . . |
| | | basic patterns, | basic patterns, | basic patterns, | |
| | | specific patterns; | specific patterns; | specific patterns; | |

Where the category represents a main category to which unique identifier belongs (e.g. regular activity, medium risk activity, high risk activity, etc.), and the ID_type represents certain medium or high-risk static attributes associated with the user unique identifier. The remainder of the reason code contains one or more sets of information characterizing different types of network traffic associated with the user device. Characterized network traffic may include application-to-device traffic, device-to-device phone traffic data, application-to-application traffic data, etc. For each type of network traffic, the reason code may include basic patterns identified in data associated with that traffic type, and specific patterns identified in data associated with that traffic type. For example, for device-to-device traffic, the scoring module may maintain a record of basic traffic patterns such as successful calls, call duration, tenure and range patterns. Data representing those basic traffic patterns may be stored in association with the traffic type and provided in the reason code. As another example, for device-to-device traffic, the scoring module may maintain a record of specific traffic patterns such as call activity towards a high number of different phone numbers or call activity concentrated in short time intervals. In such a case, data representing these specific traffic patterns may be stored in association with the traffic type and provided in the reason code. By building reason codes in this fashion, the scoring module 260 is capable in providing valuable characterizing data in support of the overall score that is generated.

In some implementations, the scoring module 260 may combine the risk score with other methods of scoring a unique identifier and/or apply “score aging” to adjust the score based on the age of the telecommunications network data used to generate the risk score. For example, activities from more recent telecommunication network data will typically be more reflective of a user's likely behavior as compared with activities from older telecommunication network data.

The fraud assessment module 270 interprets the score that is generated by the scoring module 260 and generates an assessment of the likelihood that the received unique identifier is associated with fraud. In an example implementation where the unique identifier is a phone number, the fraud assessment module 270 assigns a characterization based on the calculated score. For example, a score of 1-100 may indicate an “unknown” user classification (i.e., insufficient information to classify), a score of 100-500 may indicate a “good” user classification, a score of 500-600 may indicate a “suspicious” user classification, and a score of 600-1000 may indicate a user classification of “fraudulent.” The fraud assessment module 270 may be provided, for example, as part of the risk assessment service offered by the risk assessment system and accessed by various network services, such as web sites, applications, storage services, financial services, and so on. The fraud assessment module 270 may generate one or more of a risk score and a reason code or classification.

The following table provides a representative example of a score (generated by the trained ML models), category, risk level, and recommendation that might be generated by the risk scoring model. The corresponding description may be associated with the particular category to provide a simple narrative that characterizes the activity of the user in a ready fashion:

| Score | Category | Risk level | Recommendation | Description |
|---|---|---|---|---|
| 1-200 | Good | Very Low | Allow | Users with non-risky |
| | | Risk | | static attributes and |
| | | | | continuous regular |
| | | | | activity. |
| 201-400 | Unknown | Low Risk | Allow | Users with non-risky |
| | | | | static attributes and |
| | | | | nonfraudulent activity. |
| 401-500 | Suspicious | Low Risk | Flag | Users with medium-risky |
| | | | | static attributes and/or |
| | | | | light suspicious activity. |
| 501-600 | Suspicious | Medium | Flag | Users with medium-risky |
| | | Risk | | static attributes and/or |
| | | | | suspicious activity. |
| 601-800 | Fraud, | High Risk | Block | Users with medium-risky |
| | Application, | | | static attributes and/or |
| | Call Center | | | fraudulent or non- |
| | | | | human-like activity. |
| 801-1000 | Fraud, | Very High | Block | Users with high-risky |
| | Application, | Risk | | static attributes and/or |
| | Call Center | | | very fraudulent or non- |
| | | | | human-like activity. |

While the description of the system herein has focused on distinguishing fraudulent users from non-fraudulent users, it will be appreciated that the system can also be trained to detect other classes or categories of users that might be of interest to identify. For example, one class of user that uses network communication sessions are applications running on mobile devices. The system may therefore be provided with a list of unique identifiers associated with applications in order to assess the network traffic generated by those applications and train a model to recognize that application traffic. Another class of user that generates traffic may be call centers, which make and receive a significant number of calls. Again, the system may be provided with a list of unique identifiers associated with call centers, from which historical network traffic may be identified and used to train a model to detect call center traffic. Other classes of users may be identified and utilized by the system to train models for detection as well.

In an example implementation, a service provider accesses the system 200 via an application programming interface (API) and transmits a telephone number associated with a user's request to access a network service. The service provider may receive a telephone number associated with a user, for example, when the user submits a request to access a network service (e.g., a web site or application). In response to receiving the telephone number, the system generates a risk assessment using the stored risk scoring model. The generated risk assessment may include a risk score for the phone number, a reason code explaining reasons for the risk score, a prediction as to whether the user associated with the phone number is likely be a fraudulent or non-fraudulent user, and a recommendation to block, flag, or allow access. The risk assessment generated by the system 200 is then transmitted back to the service provider to help inform the decision to allow or block the user's access to the requested network service, or to require additional verification or authentication of the user.

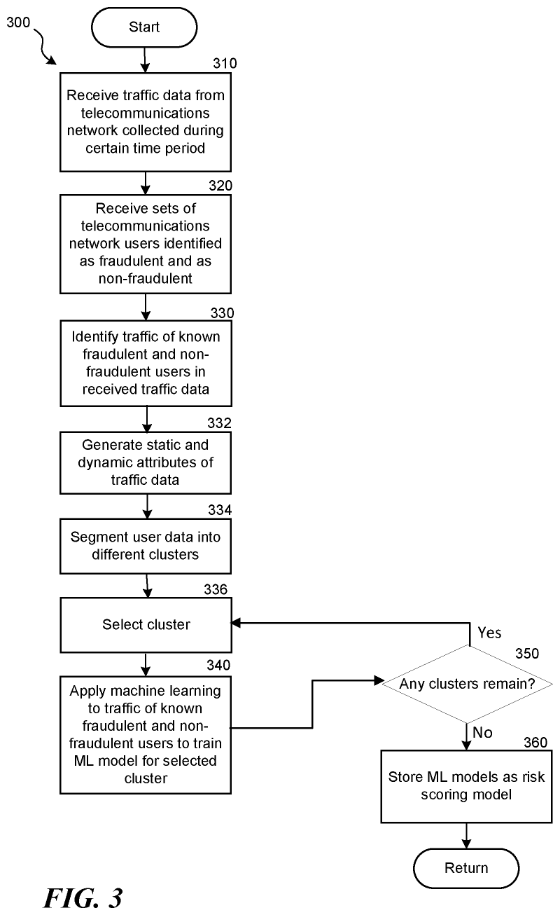

FIG. 3 is a flow diagram illustrating an example process 300, implemented by a risk assessment system, for generating a risk scoring model. In general, the process 300 includes receiving telecommunications network traffic data, receiving sets of known fraudulent and non-fraudulent users of the telecommunications network, identifying within the received traffic data the data associated with the known fraudulent and non-fraudulent users, clustering the users based on static or dynamic attributes associated with the user and the corresponding traffic associated with that user, training a machine learning model for each cluster using known fraudulent and/or non-fraudulent user data such that the ML model is able to assess a likelihood of fraud based on the data, and storing the trained ML models associated with each cluster as a risk scoring model.

The process begins at a block 310, where the system receives traffic data from a telecommunications network reflecting traffic associated with that network for a certain time period. For example, the traffic data may reflect the last 30 days of network traffic, the last 3 months of network traffic, a prior calendar year of network traffic, etc. The traffic data includes a variety of data associated with sessions over a telecommunications network (e.g., calls and messages) and unique identifiers associated with each network session. This data may include for each session, for example, a phone number generating a call and a phone number receiving a call, a type for each phone number, an operator name and operator country for each phone number, whether or not a phone number is associated with a Value-Added Service (VAS), whether or not a phone number is suspected to be associated with fraud, whether or not a phone number is believed to be engaged in Application-to-Person (A2P) messaging, and/or whether or not a phone number can be associated with a known range of phone numbers. The data may also include, or be analyzed by the system to generate, various dynamic attributes associated with phone numbers, such as information regarding the number of successful and unsuccessful sessions associated with a phone number for a specified time period (e.g., successful or unsuccessful phone calls or messages sent or received), information regarding the number of different phone numbers with which a phone number has transacted traffic for a specified time period (e.g., how many phone numbers did a given phone number call or message during a sent time period, and how many phone numbers called or messaged that same phone number during that time period), information regarding location of origin and location of destination of sessions associated with a phone number for a time period (e.g., to how many countries did a phone number send calls or messages during a time period, from how many countries did a phone number receive calls or messages during that same time period), and so forth. While block 310 contemplates that data is received from a single telecommunication network, it will be appreciated that data can also be received from multiple communication networks.

At a block 320, the system receives a set of telecommunications network users known to fall within the desired user classes sought to be detected. For example, if the system is to be trained to distinguish between fraudulent and non-fraudulent users, the system receives a set of telecommunications network users known or believed to be fraudulent and a set of telecommunications network users known or believed to be non-fraudulent. The received sets of characterized users are used by the system to generate the risk scoring model. The sets of known fraudulent and non-fraudulent users may be maintained by the system operator or may be provided by other service providers. Users classified as “fraudulent” may have been found to have participated in unapproved activities such as service misuse, promo abuse, spam, phishing attacks, or any other disruptive activities. Fraudulent and non-fraudulent users are identified by the corresponding unique identifier associated with each user. Alternatively, the list of fraudulent and non-fraudulent users may also include data which characterizes the scope and type of fraudulent activities that the user was either found to have undertaken or is believed to have undertaken. If other classes of users are intended to be recognized by the system, then at block 320 the system also receives lists of the unique identifiers that are associated with those other user classes.

At a block 330, the system identifies past telecommunications network traffic data associated with fraudulent and non-fraudulent users from the received traffic data. The identified network traffic data typically spans a given time period, such as 3 months, 6 months, or 1 year. The identified network traffic data represents all network activities undertaken by users within the corresponding time period. In some cases, the identified users may not have any corresponding network activity in which case those users are discarded from the training data set. In other cases, the identified users may have an insufficient number of network sessions from which to draw meaningful information. For example, the number of network telecommunication sessions associated with an identified user in the identified time period may be three or fewer sessions. In that case, the system may elect to omit those users from the training data set since the amount of network session data would be insufficient for effective training purposes. However, in some cases users with low traffic volume will not be omitted from the training data set, for example, because the data may include other meaningful information associated with the user (e.g., range behavior, email activity, IP activity, short-term activity that appears suspicious or fraudulent). Instead, these low-volume users can be treated as a separate “unknown/low activity” cluster for further analysis as described herein. Additionally or alternatively, users or categories of users for which little data is available can be duplicated in the training data to balance the training data set.

After identification of network session data associated with each user, at a block 332 the system processes the network data to generate certain data characterizing network sessions. For example, the system may analyze the network session data and identify static and dynamic attributes of the data for each user. Static attributes are characteristics of the network session that are invariant, such as the number type, type of connection, operator name and country, etc. In contrast, dynamic attributes are calculated or identified using one or more characteristics across one or many network sessions. In an example implementation involving voice calls and SMS messaging using phones, a velocity dynamic attribute may be defined based on the number of successful or unsuccessful sessions of a phone number calling or called for a specified time period, where a session is a voice call or SMS message. A voice call is considered to be successful if the call is answered and the call duration is greater than zero. A SMS message is considered successful if there is no error indicated. A velocity dynamic attribute as defined above may, for example, give an indication of an unusual frequency of unsuccessful voice calls from the same phone number. As a further example, a count dynamic attribute may be defined based on the number of different phone numbers calling or called by a phone number during a given time period. A count dynamic attribute as defined above may, for example, give an indication of an unusual number of voice calls to different phone numbers in a certain period of time.

In an example calculation of a defined dynamic attribute where the defined dynamic attribute is a velocity, the velocity may be measured as the number of [success/unsuccessful/both successful and unsuccessful] [SMS/Voice/both SMS and voice] sessions associated with a particular unique identifier, if the unique identifier is [calling/called/calling or called] during an analyzed time period, wherein the velocity may be calculated based on one or more of each of the bracketed measures. Other measures that may be used to calculate a velocity include call duration, call setup time, calls with at least one retry, and statistical analyses of dynamic or static attributes (e.g., mean, median, peaks, standard deviation, etc.).

The system analyzes attributes of the traffic data according to multiple such defined dynamic attributes, including other dynamic attributes relating to count or velocity, traffic types, traffic ranges, peaks or spikes, averages, and other variables. Dynamic attributes may be calculated based on call setup duration, call frequency, call duration, SMS message retries, counts based on country of origin destination, counts based on sessions with numbers within a range, counts based on transmitting or receiving operator for a session, counts based on a number type (e.g., VAS, toll-free, VoIP, invalid, premium, A2P, etc.) included in a session, tenure or active tenure of a number, counts based on active days for a number, and ranges, peaks, spikes, averages, means based on the foregoing, and so on. Attributes that are generated by the system are stored in conjunction with the unprocessed network data and used for purposes of model training.

At a block 334, the system segments the user data into different clusters. The clusters are based on static and/or dynamic attributes of the network traffic. For example, based on the number of calls (i.e., velocity) associated with phone numbers, the system may segment phone numbers into clusters representing calls having a high volume, a medium volume, or a low volume of calls. As another example, the system might cluster calls based on unusual static properties, such as percentages of premium calls, tollfree calls, or value-added service (VAS) connections rather than standard voice calls. As yet another example, a clustering operation can separate traffic data into a first category of identifiers associated with unusual outgoing call activity, a second category associated with unusual incoming call activity, a third category for unusual static attributes, and a fourth category of potential good users into which all other identifiers are clustered. The first and second categories can be further clustered according to whether an identifier is associated with unusual range activity or unusual velocity activity. While three examples of clustering are provided, it will be appreciated that the system may cluster the user data based on any static or dynamic attribute identified from the network traffic. The clusters generated by the system thereby represent groups of like users, as well as the corresponding network traffic data associated with those users, that can then be used in further analysis and training by the system.

After segmentation of the user data into clusters, the system utilizes the data in each cluster to train a machine learning models to recognize fraudulent and non-fraudulent activities of new users having traffic similar to users found in the corresponding cluster. At a block 336, the system selects a cluster for processing. At a block 340, the system applies a machine learning algorithm to the identified traffic data, static attributes, and/or dynamic attributes to train the ML model for that cluster to recognize attributes that are indicative of fraudulent users (i.e., the user class sought to be detected in the cluster). Machine learning methods utilized by the system may include supervised, semi-supervised, or unsupervised machine learning algorithms. Unsupervised machine learning algorithms may include clustering methods (e.g., k-means, k-medoids, hierarchical clustering) and dimensionality reduction algorithms (e.g., principal component analysis (PCA), linear discriminant analysis (LDA)). Supervised machine learning algorithms may include logistic regression and multinomial logistic regression, support vector machines, neural networks, deep learning algorithms (stacked autoencoders), and bagging/boosting algorithms (e.g., random forest, xgboost, gradient boosting machines, light gbm, etc.).

The ML model is trained to identify those attributes that are correlated with fraudulent and non-fraudulent users, based on network traffic data and attribute values and ranges of values that are likely indicative of fraudulent or non-fraudulent users. The resulting trained model returns a probabilistic assessment of either fraudulent or non-fraudulent activity, meaning that when applied to traffic data associated with a new user, it will generate a score reflecting the likelihood that the new user is likely to participate in fraudulent or non-fraudulent behavior. That score may be scaled, for example, between a range of 1-1000, where scores over a certain threshold (e.g., over 600) reflect that the user is likely to participate in fraudulent behavior and scores under another threshold (e.g., under 300) reflect that the user is likely to participate in non-fraudulent behavior. Scores falling between the two thresholds (e.g., scores between 300-600) may reflect an increasing likelihood or suspicion that a user will commit fraud, although with less certainty than users associated with a higher score.

At a decision block 350, the system determines whether any clusters remain to be analyzed. If clusters remain, processing continues to block 336 where another cluster is selected for analysis and to block 340 where a ML model is trained for that selected cluster. If no clusters remain for analysis at block 350, however, then processing continues to a block 360.

At block 360, the system stores the ML models as an overall risk scoring model. The risk scoring model comprises a set of ML models that are used to assess traffic data associated with new users. The risk scoring model generates scores reflecting the likelihood that a new user will participate in fraudulent or non-fraudulent activities, based on the characteristics of the prior network traffic of that user. The system uses the generated risk scoring model to assess risk of fraud associated with a unique identifier, for example, through the risk assessment service that is described in additional detail herein.

The depicted process 300 shown in FIG. 3 represents just one embodiment of how a system may generate a risk scoring model according to the present technology. In other embodiments, the operations of process 300 can be altered while still maintaining a similar functionality. For example, while the process 300 is applied in the context of telecommunication networks, the present technology may be applied in the context of other networks. The process (e.g., at block 340) may utilize other machine learning or computational models. Furthermore, the present technology is not limited to detecting fraudulent and non-fraudulent users of a network, and may be applied more broadly to identifying other classes of users.

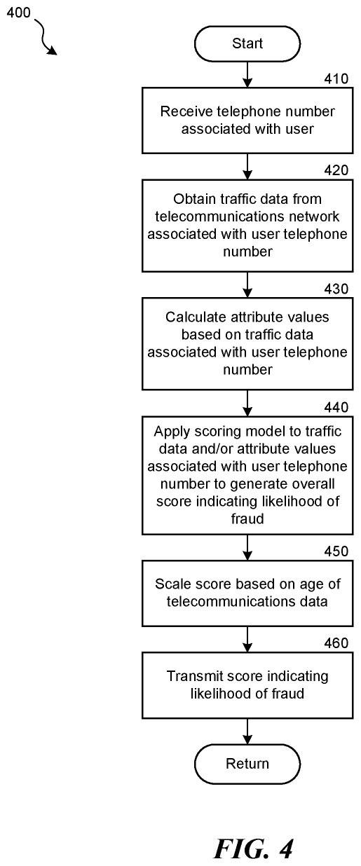

FIG. 4 is a flow diagram of an example process 400, implemented by a fraud assessment system, to assess the risk of fraud associated with a unique identifier. In this example implementation, the unique identifier is a telephone number. In general, the process 400 includes receiving a telephone number associated with a user, obtaining traffic data associated with the telephone number from a telecommunications network, calculating attribute values based on the obtained traffic data, applying the risk scoring model to the traffic data and/or calculated attribute values, generating a risk score indicating the likelihood that the telephone number is associated with fraud, applying a scaling factor to the risk score based on the age of the obtained traffic data, and transmitting the scaled risk score.

The process 400 begins at a block 410, where the system receives a telephone number associated with a user. The telephone number may be provided by the user, for example, as part of a registration request to access a network service such as a web site or application. The system may receive the telephone number from the user or from the network service.

At a block 420, the system obtains traffic data associated with the telephone number from a telecommunications network. The traffic data may be maintained within the system, such that obtaining traffic data associated with the telephone number entails a look-up in a stored dataset of all network sessions associated with that telephone number within a period of time (e.g., 2 months, 3 months, 6 months, etc.). Alternatively, the system may submit a query to an external source to obtain the traffic data, such as a request to a telecommunications network provider. The traffic data is obtained in one or more datasets representing all sessions over a telecommunications network for one or more specified time periods. In some implementations, the obtained traffic data is a base set of traffic data extracted from a larger dataset. Within the obtained traffic data, the system identifies traffic data associated with the received telephone number by searching the network traffic for any session that either originates with or terminates with the received telephone number.

At a block 430, the system calculates attribute values based on traffic data associated with the telephone number. These values include static and dynamic attributes of the traffic data, as described herein above, such as velocity and count attributes, peaks, ranges, averages, and so on.

At a block 440, the system applies the risk scoring model to the traffic data and/or the attribute values associated with the telephone number. Applying the risk scoring model involves determining static or dynamic attributes characterizing the network traffic associated with the telephone number, attributing the telephone number to one of the user clusters represented in the risk scoring model based on the static or dynamic attributes, applying the ML model associated with the attributed cluster to the network traffic and/or static or dynamic attributes associated with the telephone number, and generating a risk score based on the applied ML model. The system generates, based on the risk scoring model, a risk score indicating the likelihood that the telephone number is associated with fraudulent activity. As described herein, the system generates a score such as a numerical score between 0 and 1000, wherein a lower score indicates a lower likelihood that the telephone number is associated with fraud and a higher score indicates a higher likelihood that the telephone number is associated with fraud. The following table represents one example of a correspondence between a score and the likelihood that the telephone number is associated with fraudulent activity:

| Score Range | Interpretation |
|---|---|
| 1-100 | Unknown |
| 100-500 | Non-fraudulent users |
| 500-600 | Suspicious users |
| 600-950 | Likely fraudulent users |
| 950-1000 | Clearly fraudulent users |

At a block 450, the system may optionally scale the generated risk score based on the age of the obtained traffic data. In general, risk scores generated based on more recent traffic data are more accurate than risk scores generated for older traffic data. As such, the generated risk score can be scaled to account for the age of the obtained traffic data when the score is generated. A risk score is reduced if based on older traffic data to reflect the lessened accuracy when using that data.

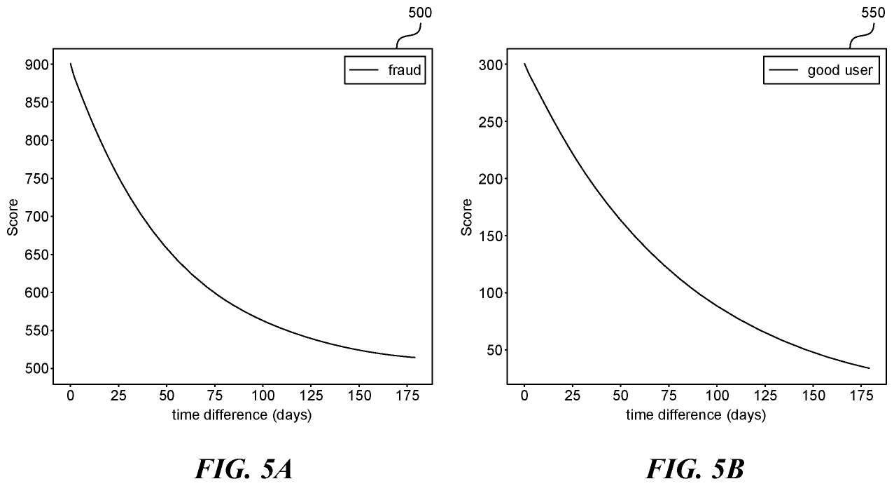

In addition to scaling the risk score based on age of traffic data, the generated risk score may also be combined with other scores generated by different risk scoring models, taking into account differences in time between the scores generated by the respective models and the datasets analyzed by the respective models. When results from two different models are combined, the system can scale one of the scores to take into account the difference in time between when the two models were generated. A method for scaling the risk score will be described in additional detail with respect to FIGS. 5A and 5B.

At a block 460, the system transmits the scaled risk score. As described herein, the system may be used, for example, by a network service in deciding whether to grant or deny an access request, or to require additional steps such as user verification or authentication. Therefore, at block 460 the system transmits the score, such as by sending the score to the network service. The network service can use the score to assess risk that the scored user may pose if allowed to access the service.

The depicted process 400 shown in FIG. 4 represents just one embodiment of assessing risk of fraud associated with a unique identifier according to the present technology. In other embodiments, the operations of process 400 can be altered while still maintaining a similar functionality. For example, instead of receiving a telephone number (e.g., at block 410), the system may be configured to receive another kind of subscriber identifier or other identifier associated with a user of a network, such as an international mobile subscriber identity (IMSI), international mobile equipment identity (IMEI), email address, Internet Protocol (IP) address, or other number, address, or code that identifies a user of a network. In such alternative embodiments, the system (e.g., at blocks 420 and 430) would receive and analyze network data according to the network or networks accessed by the user associated with such user identifier. In some embodiments, the system may generate an overall risk score for an identifier without scaling the score based on age of the data (e.g., as shown at block 450). In some embodiments, the system may combine the generated risk score (e.g., at block 440) with another risk score, such as a score generated by an alternative scoring model, before transmitting the combined score (e.g., at block 460).

In some embodiments, the process 400 can also include generating and transmitting qualitative assessments of likelihood of fraud associated with a telephone number. For example, in addition to a risk score, the system can provide a predicted user category associated with the telephone number, a recommendation to allow, block, or flag the user, a reason code, or a narrative explanation of factors or attributes that materially affected the generated risk score.

FIGS. 5A and 5B represent graphs that are used to scale risk scores that are based on older network traffic data. Risk scores can be scaled under two circumstances. First, a new risk score being calculated by the system can be scaled if the underlying network traffic data used to calculate that risk score is older data. Since older traffic data may not represent the current behavior of the corresponding user, the risk score is reduced to take into account the reduced confidence in the network traffic data. Second, if a new risk score is being combined with a previously-generated risk score in order to arrive at a composite risk score, the previously-generated risk score can be scaled to account for the age of the previously-generated risk score.

FIG. 5A illustrates a graph 500 that is used to scale a risk score of 900 associated with a likely fraudulent user. The y-axis of graph 500 reflects the risk score value, either a newly-generated risk score or a previously-generated risk score. The x-axis represents the age of the network traffic data (in days) on which the risk score is based. The age can represent the age of network data used to calculate a new risk score. For example, if a risk score of 900 is calculated for a unique identifier using network data that is 50 days old, using the graph the calculated score of 900 is scaled by the system to approximately 650 to reflect the uncertainty associated with the age of the underlying network data. Alternatively or additionally, if the system is combining a previously-generated risk score with a newly-calculated risk score, the age can represent the elapsed time between when the previously-generated risk score was generated and when it is now being used. For example, if a previously-generated risk score had a value of 900, and 100 days later the system was going to combine that score with a newly-generated risk score associated with the same user identifier, using the graph the system can adjust the original score of 900 to approximately 575 since the data on which is based is no longer current. The older score can then be added to, averaged with, or otherwise used to modify the newly-generated risk score in order to arrive at a composite score. As reflected by the shape of the graph 500, the risk score is adjusted significantly downward during the first 75 days, with the rate of adjustment slowing as the time difference approaches 175 days. The curve approaches the score limit of 500 (i.e., a “suspicious user” in the table above), but does not go below that limit regardless of the age of the underlying data. FIG. 5A depicts one adjustment curve, but it will be appreciated that different shaped adjustment curves may be utilized depending on the particular user class and the starting risk score.

In contrast, FIG. 5B illustrates a graph 550 that is used to scale a risk score of 300 associated with a likely non-fraudulent user. In a similar fashion to FIG. 5A, the y-axis of graph 550 reflects the risk score value, either a newly-generated risk score or a previously-generated risk score. The x-axis represents the age of the network traffic data (in days) on which the risk score is based. The age can represent the age of network data used to calculate a new risk score. Alternatively or additionally, if the system is combining a previously-generated risk score with a newly-calculated risk score, the age can represent the elapsed time between when the previously-generated risk score was generated and when it is now being used. As reflected by the shape of the graph 550, the risk score is adjusted downward during the first 75 days, with the rate of adjustment slowing as the time difference approaches 175 days. The curve approaches the score limit of 0 (i.e., “unknown” in the table above), but does not go below that limit regardless of the age of the underlying data. FIG. 5B depicts one adjustment curve for non-fraudulent users, but it will be appreciated that different shaped adjustment curves may be utilized depending on the particular user class and the starting risk score.

In general, the detailed description of embodiments of the present technology is not intended to be exhaustive or to limit the present technology to the precise form disclosed above. While specific embodiments of, and examples for, the present technology are described above for illustrative purposes, various equivalent modifications are possible within the scope of the present technology, as those skilled in the relevant art will recognize. For example, while processes (or steps) or blocks are presented in a certain order, alternative embodiments can perform routines having steps, or employ systems having blocks, in a different order, and some processes or blocks can be deleted, moved, added, subdivided, combined, and/or modified. Each of these processes or blocks may be implemented in a variety of different ways. Also, while processes or blocks are at times shown as being performed in series, these processes or blocks may instead be performed in parallel, or can be performed at different times.

These and other changes can be made to the disclosed technology in light of the above Detailed Description. While the above description describes certain examples of the disclosed technology, no matter how detailed the above appears in text, the disclosed technology can be practiced in many ways. Details of the system and method may vary considerably in their specific implementations, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. In general, the terms used in the following claims should not be construed to limit the disclosed technology to the specific examples disclosed in the specification, unless the above Detailed Description section explicitly defines such terms.

I/We claim:

1. A computer-implemented method for assessing risk of fraud associated with a unique identifier, the method comprising:
receiving a unique identifier for a telecommunication device associated with a user;
querying a telecommunication network traffic dataset to identify historical telecommunication network use by the telecommunication device associated with the unique identifier;
receiving, in response to the query, data characterizing historical telecommunication network use associated with the unique identifier;
analyzing the received telecommunication network use data associated with the unique identifier to identify a plurality of attribute values indicative of potentially fraudulent use by the user of the telecommunication device; and
generating a risk score based on the plurality of attribute values to indicate a risk of fraud associated with the unique identifier.

2. The method of claim 1, wherein the unique identifier is a telephone number.

3. The method of claim 1, wherein the telecommunication device is a smartphone.

4. The method of claim 1, wherein the received telecommunication network use data is analyzed based on a risk scoring model generated by analysis of historical telecommunication network use.

5. The method of claim 4, wherein the risk scoring model is generated using machine learning.

6. The method of claim 1, wherein the data characterizing telecommunication network use includes data associated with a plurality of voice or short message service (SMS) sessions.

7. The method of claim 1, wherein the plurality of attribute values includes static and dynamic attributes of network use associated with the unique identifier.

8. The method of claim 7, wherein one of the dynamic attributes is a velocity attribute calculated based on a quantity of telecommunication network sessions associated with the unique identifier during a specified time period.

9. The method of claim 1, further comprising:
generating a reason code wherein the reason code corresponds to the risk score and a likely user classification associated with the unique identifier.

10. The method of claim 1, further comprising:
transmitting the risk score to a service to assist the service in deciding to grant or deny an access request, or require additional verification.

11. The method of claim 1, further comprising:
generating a combined score, wherein the combined score is generated based on the risk score and a previously-generated risk score, and wherein the previously-generated risk score is adjusted based on any difference in time between when the risk score was generated and when the previously-generated risk score was generated.

12. The method of claim 1, further comprising:
applying a scaling factor to the risk score based on an age of the received telecommunication network use data.

13. A computer-implemented method for analyzing network use behavior associated with a mobile telephone of a user to assess a likelihood of fraudulent activity by that user, the method comprising:
receiving a mobile telephone number associated with the user;
receiving a dataset of network traffic representing network sessions on a telecommunications network in a defined time period;
identifying, within the dataset, network sessions associated with the mobile telephone number;
analyzing the network sessions associated with the mobile telephone number to identify dynamic attribute values associated with likely fraudulent activities; and
assigning a risk score to the mobile telephone number based on the identified dynamic attribute values.

14. The method of claim 13, wherein the network traffic associated with the mobile telephone number comprises a plurality of voice calls and short message service (SMS) messages transacted through the telecommunications network.

15. The method of claim 13, wherein the risk score is assigned using a risk scoring model generated by analysis of network traffic using machine learning.

16. The method of claim 13, wherein the risk score is a numerical score.

17. A non-transitory computer-readable medium containing instructions configured to cause one or more processors to perform a method of assessing risk of fraud associated with a unique identifier, the method comprising:
receiving a unique identifier for a telecommunication device associated with a user;
querying a telecommunication network traffic dataset to identify telecommunication network use by the telecommunication device associated with the unique identifier;
receiving, in response to the query, data characterizing telecommunication network use associated with the unique identifier;
analyzing the received telecommunication network use data associated with the unique identifier to identify a plurality of attribute values indicative of fraud; and
generating a score based on the plurality of attribute values to indicate a risk of fraud associated with the unique identifier.

18. The non-transitory computer-readable medium of claim 17, wherein the unique identifier is a telephone number and the telecommunication device is a mobile phone.

19. The non-transitory computer-readable medium of claim 17, wherein the received telecommunication network use data is analyzed based on a risk scoring model generated by analysis of historical telecommunication network use.

20. The non-transitory computer-readable medium of claim 19, wherein the risk scoring model is generated using machine learning.
